(19) United States
(12) Patent Application Publication
(10) Pub. No.: US 2025/0094704 A1
(43) Pub. Date: Mar. 20, 2025

(54) LLM FINE-TUNING FOR TEXT SUMMARIZATION

(71) Applicant: ORACLE INTERNATIONAL CORPORATION, Redwood Shores, CA (US)

(72) Inventors: Yazhe HU, Bellevue, WA (US); Mengqing GUO, Issaquah, WA (US); Zheng WANG, Sammamish, WA (US); Tao SHENG, Bellevue, WA (US); Jun QIAN, Newcastle, WA (US); Vinod MAMTANI, Bellevue, WA (US)

(21) Appl. No.: 18/627,860

(22) Filed: Apr. 5, 2024

Related U.S. Application Data
(60) Provisional application No. 63/538,663, filed on Sep. 15, 2023.

(51) Int. Cl. G06F 40/226

(52) U.S. Cl. CPC G06F 40/226

(57) ABSTRACT

Systems, methods, and other embodiments associated with automated fine-tuning of text summarization for large language models are described herein. In one embodiment, a method accesses a collection of text samples. The text samples include a body of text and an example summary. The method fine-tunes a large language model (LLM) based on a loss function that compares the example summary and a generated summary generated by the LLM. The example and generated summaries are compared at sentence, paragraph, and/or article levels. The method generates an evaluation score for performance of the tuned LLM as a text summarizer based on a further comparison of a reference summary and a summary generated by the tuned LLM. The method then automatically determines to deploy the tuned LLM to a text summarization task in response to the evaluation score satisfying a threshold.

### CROSS REFERENCE TO RELATED APPLICATIONS

This disclosure claims the benefit of U.S. Provisional Patent Application Ser. number “63/538,663” filed Sep. 15, 2023, titled “Large Language Model Fine Tuning”, having inventors: Yazhe HU, Zheng WANG, Mengqing GUO, Tao SHENG, Jun QIAN, and Vinod MAMTANI, and assigned to the present assignee, the entirety of which application is incorporated by reference herein in its entirety.

### BACKGROUND

A large language model (LLM) is an artificial intelligence system that has been trained on vast amounts of text data to generate appropriate human language text responses to human language prompts. A LLM is capable of performing many diverse tasks, such as text summarization. It is not currently possible to automatically evaluate and improve the performance of the LLM for text summarization.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a summarization tuning system associated with automated LLM fine-tuning for text summarization.

FIG. 2 illustrates an example summarization tuning pipeline for automated fine-tuning of an LLM-based text summarizer.

FIG. 3 illustrates one embodiment of a summarization tuning method associated with automated LLM fine-tuning for text summarization.

FIG. 4 illustrates an embodiment of a computing system configured with the example systems and/or methods disclosed.

### DETAILED DESCRIPTION

Systems, methods, and other embodiments are described herein that provide automated fine-tuning of text summarization for large language models (LLMs). In one embodiment, a summarization tuning system automatically fine-tunes an LLM to improve LLM handling of natural language text summarization. For example, the summarization tuning system automatically adjusts the LLM to cause the LLM to generate outputs that are more closely aligned with expectations for generating a summary of a passage of natural language text. And, for example, the summarization tuning system automatically evaluates improvement of LLM summarization performance to control deployment of the improved LLM to a production environment. In one embodiment, the LLM summarization tuning system quantifies improvement to the performance of the LLM at the task of summarization, rendering the improvement verifiable.

In one embodiment, the summarization tuning system implements a pipeline for LLM fine-tuning on text summarization. In one embodiment, the summarization tuning system is a clear improvement over traditional techniques for LLM fine-tuning on text summarization. Unlike traditional techniques which use prompt engineering or in-context learning to improve text summarization ability of an LLM, in one embodiment, the summarization tuning system integrates use of specialized text summarization training data with automated evaluation of iterative improvement to the LLM. In one embodiment, the pipeline implemented by the summarization tuning system uses customized text summarization training data to fine-tune LLM weights for optimized text summarization performance. Meanwhile, the pipeline uses automatic text summarization evaluation to iteratively analyze the improvement/degradation of the fine-tuned LLM in order to obtain improved (e.g., optimized) LLM weights for text summarization. In one embodiment, the summarization tuning system automatically evaluates and analyzes the ability of the LLM to summarize text without human evaluator involvement.

### Definitions

As used herein, the term “fine-tuning” refers to the process of taking a pre-trained LLM and further training it on a specific task or domain—such as text summarization—with a narrower dataset that is targeted to the specific task or domain.

As used herein with reference to a text, the terms “summarize” and “summarization” refer to condensing a text into a natural language overview of the main ideas, arguments, events (or other conceptual elements) of the text that is more concise or shorter than the text.

As used herein, the term “natural language” refers to a language that is used among humans for linguistic communication, such as a language that people use in everyday conversations, reading, and writing. Example natural languages include English, Spanish, Mandarin, Hindi, Arabic, and a wide variety of others. For purposes of this application, the term “natural language” includes classical languages such as Latin, Sanskrit, and Literary Chinese, and constructed or auxiliary languages such as Esperanto and Interlingua.

As used herein, the term “recall” refers to an extent to which words or phrases in an example or expected summary of a text also occur in in LLM-generated summaries of the text. More formally, recall indicates a proportion of relevant items in the example (reference) text that were identified in the LLM-generated summary of the text.

As used herein, the term “precision” refers to an extent to which words appear in the same order in both the LLM-generated summary of a text and an example or expected summary of the text. Precision thus indicates a proportion of items in the LLM-generated summary that preserve meanings expressed in the example (reference) text, suggesting that the items are truly relevant to the example text.

It should be understood that no action or function described or claimed herein is performed by the human mind. No action or function described or claimed herein can be practically performed in the human mind. An interpretation that any action or function described or claimed herein can be performed in the human mind is inconsistent with and contrary to this disclosure.

### —Example Summarization Tuning System for LLMs—

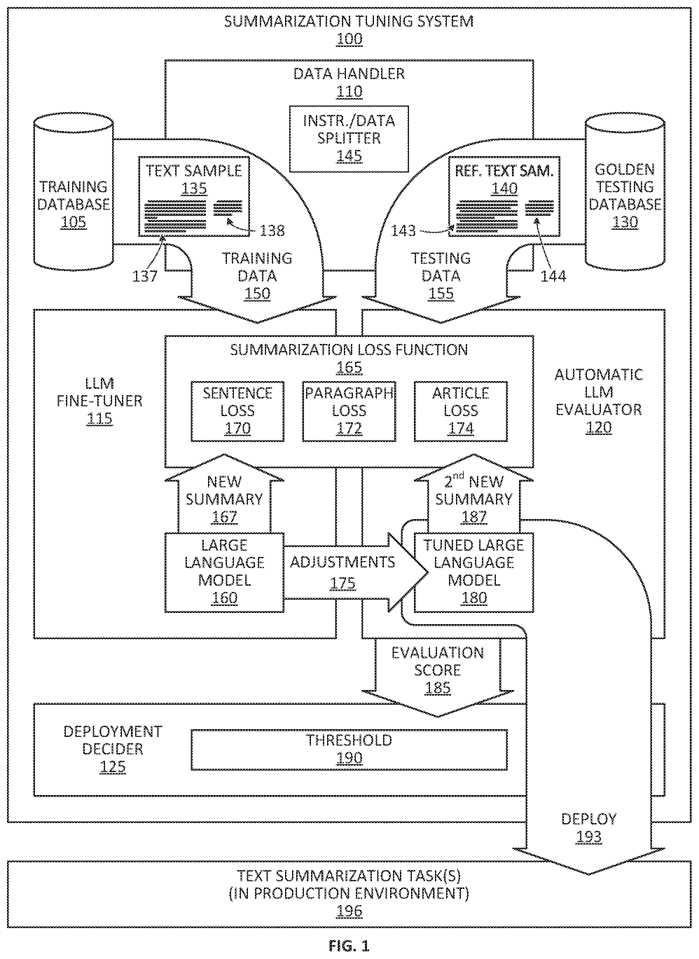

FIG. 1 illustrates one embodiment of a summarization tuning system 100 associated with automated LLM fine-tuning for text summarization. Summarization tuning system 100 includes components for (i) automatically fine-tuning a LLM to generate outputs that more closely track expected summaries of natural text, and then (ii) automatically testing the extent to which the performance of the LLM has improved in natural language text summarization using a golden benchmarking dataset that is specific to natural language text summarization. In one embodiment, the components of summarization tuning system 100 include training database 105, data handler 110, LLM fine-tuner 115, automatic LLM evaluator 120, deployment decider 125, and golden testing (benchmarking) database 130.

In one embodiment, data handler 110 is configured to access training database 105. Training database 105 includes a collection of text samples 135. Thus, in one embodiment, data handler 110 is configured to access a collection of text samples 135. A text sample 135 includes a body of text 137 in a natural language, and an associated example summary 138 of the body of text 137. In one embodiment, the example summary 138 of the body of text 137 is in the natural language used by the body of text 137. In one embodiment, data handler is configured to access golden testing database 130. Golden testing database 130 includes a collection of reference text samples 140 designated as benchmarks for evaluating success of LLM training. Reference text samples 140 include a reference body of text 143 and an associated reference summary 144, similar to text sample 135. Data handler 110 is configured to pass the text samples 135 as training data 150 to LLM fine-tuner 115. Data handler 110 is configured to pass the reference text samples 140 as reference data 155 to automatic LLM evaluator 120.

In one embodiment, data handler 110 further includes instruction/data splitter 145. Instruction/data splitter 145 is configured to parse instructions out of a body of text 137, 143 of a text sample 135, 140, for example separating, in the body of text 137, instructions to an LLM 160 regarding summarizing a text from the text (e.g., an article) to be summarized. The training data 150 and testing data 155 may include the text samples 135, 140 either (i) unmodified from the form stored in databases 105, 130 or (ii) following modification by instruction/data splitter 145, with instructions to the LLM 160 separated from the text to be summarized.

In one embodiment, LLM fine-tuner 115 is configured to fine-tune a large language model 160, as discussed in further detail below. The fine-tuning by LLM fine-tuner 115 is based on a summarization loss function 165. In one embodiment, summarization loss function 165 is configured to numerically quantify an effectiveness of the LLM 160 at a task of summarizing a body of natural-language text. For example, summarization loss function 165 may be configured to generate one or more numerical outputs (such as numerical values for recall and/or precision) describing extent of similarity (or difference) between a pre-provided example summary of a text (such as example summary 138) and a generated summary of the text generated by the LLM 160 (such as new summary 167). The example summary of the text is provided as a reference for comparison, such as a target showing what a satisfactory summary of the text would resemble.

In one embodiment, summarization loss function 165 is configured to compare the example summary 138 given in the text sample 135 with a new summary 167 of the body of text 137 that has been generated by the LLM 160 from the body of text 137. For example, summarization loss function 165 is configured to compare words shared between the example summary 138 and new summary 167 generated by the large language model 145. In one embodiment, summarization loss function 165 is configured to evaluate recall between two submitted summaries, such as example summary 138 and new (LLM-generated) summary 167. In one embodiment, summarization loss function 165 is configured to evaluate precision between two submitted summaries. In one embodiment, summarization loss function 165 is configured to compare the example summary 138 and new summary 167 at sentence level by a sentence loss function 170, at paragraph level by a paragraph loss function 172, and at article level by an article loss function 174. In one embodiment, summarization loss function 165 is configured to evaluate word count of an LLM-generated summary.

In one embodiment, summarization loss function 165 is configured to evaluate recall between summaries (or corresponding portions of summaries) by generating one or more scores for recall. Sentence loss function 170, an N-sentence loss function (not shown), paragraph loss function 172, and an article loss function 174 may each be configured to produce one or more scores for recall. In one embodiment, a score for recall may be generated by determining a ratio of (i) a count of matches found in the LLM-generated summary with a set of relevant words from the example summary to (ii) an overall count of the relevant words. The set of relevant words in the example summary may be determined, for example, by filtering the reference summary to remove stop words. (“Stop words” include grammatical articles such as “a”, “an”, “the”; prepositions such as “in”, “on”, “at”; conjunctions such as “and”, “but”, “for”; and other common words such as “is”, “are”, “have”.) The overall count of the remaining set of relevant words is then taken. The relevant words are compared with the words of the LLM-generated summary to detect matches where a relevant word appears in the LLM-generated summary. The matches are then counted. The count of matches is divided by the overall count of the relevant words, generating a score for recall.

In one embodiment, summarization loss function 165 is configured to evaluate precision between summaries (or corresponding portions of summaries) by generating one or more scores for precision. Sentence loss function 170, N-sentence loss function (not shown), paragraph loss function 172, and an article loss function 174 may each be configured to produce one or more scores for precision. In one embodiment, a normalized score for precision may be generated by determining a ratio of (i) a count of matching subsequences of words found in the LLM-generated summary that match subsequences of in the example summary to (ii) a total number of subsequences in the LLM-generated summary. The set of subsequences of words appearing in the LLM-generated summary is determined, and counted to produce the total number of sequences in the LLM-generated summary. The set of subsequences of words appearing in the example summary is also determined. In one embodiment, the respective sets of subsequences of words are limited to subsequences of the relevant words in the example summary, as identified above. The sets of subsequences appearing in the LLM-generated summary and example summary are compared to identify matching subsequences in the LLM-generated summary that match subsequences in the example summary. The matching subsequences represent instances where the LLM-generated summary preserves the order of words from the reference summary. The count of the matching subsequences is then taken. The count of matching subsequences in the LLM-generated summary is divided by the total number of subsequences occurring in the LLM-generated summary, generating a score for precision.

In one embodiment, the summarization loss function 165 is configured to combine the recall and precision scores to generate single-valued scores for summarization loss between the LLM-generated and example summaries. For example, the recall and precision scores may be combined by determining the harmonic mean of the precision and the recall (also referred to as the F1 score). The harmonic mean, which is twice the quotient of the product of precision and recall divided by the sum of precision and recall is high, may, in one embodiment, be used as a loss score output from the sentence loss 170, N-sentence-loss (not shown), paragraph loss 172, and/or article loss 174. The properties of the harmonic mean causes its value to be high when both precision and recall are high, but not high when just one or the other of precision and recall are high, therefore balancing the influence of precision and recall.

In one embodiment, LLM fine-tuner 115 is configured to update, adjust, optimize, further train or otherwise fine-tune large language model 160 to tailor LLM 160 for the task of text summarization. LLM fine-tuner 115 is configured to fine-tune LLM 160 based on the multi-level (sentence-, N-sentence-, paragraph-, and/or article-level) summarization loss output of summarization loss function 165. In one embodiment, LLM fine tuner 115 may be configured to generate adjustments 175 to weights (and/or other parameters) of large language model 160. LLM fine tuner is configured to generate adjustments 175 that improve performance of large language model 160 with respect to text summarization, based on training data 150. LLM fine tuner 115 is configured to produce adjustments 175 to large language model 160 so as to minimize summarization loss function 165 when training using the training data 150.

In one embodiment, LLM fine tuner 115 is configured to generate adjustments 175 to the weights (and/or other parameters) of LLM 160 by backpropagation. LLM fine-tuner 115 is configured to iteratively adjust weights of LLM 160 in response to text samples 135 over an epoch of training that includes one or more text samples 135. The adjustments 175 may thus be a series of updates or changes to weights of nodes of the LLM 160 (or other parameters). LLM fine tuner 115 is configured to apply the adjustments 175 to the LLM 160 to create a re-trained, updated, or otherwise “tuned” LLM 180 at the end of an epoch of training. LLM fine-tuner 115 submits the tuned LLM 180 to automatic LLM evaluator 120 for evaluation of the ability of tuned LLM 180 to summarize text.

In one embodiment, automatic LLM evaluator 120 is configured to generate an evaluation score 185 for performance of the tuned large language model 180 as a text summarizer. Automatic LLM evaluator 120 is configured to generate evaluation score 185 based on a second comparison of words shared between a reference summary 144 and a second new summary 187 generated by the tuned large language model 180. For example, automatic LLM evaluator 120 may be configured to generate one or more evaluation metrics for the performance of the tuned LLM 180 based on testing data 155 from golden testing database 130. In one embodiment, automatic LLM evaluator 120 is configured to execute tuned LLM 180 to generate output of second new summary 187 in response to a prompt of reference body of text 143 from the testing data 155. And, automatic LLM evaluator 120 is configured to determine an evaluation score 185 (or other evaluation metrics) that characterizes or quantifies the performance of tuned LLM 180.

In one embodiment, automatic LLM evaluator 120 is configured to execute summarization loss function 165 to compare the reference summary 144 given in the reference text sample 140 with the 2nd new summary 187 of the reference body of text 143 that was generated by the tuned LLM 180. In one embodiment, the evaluation score 185 is based on the value of text summarization loss resulting from execution of the summarization loss function 165 on inputs of reference summary 144 and 2nd new summary 187. For example, evaluation score 185 may be the assigned the value of text summarization loss between reference summary 144 and 2nd new summary 187 given by the summarization loss function 165. In one embodiment, automatic LLM evaluator 120 is configured to provide evaluation score 185 to deployment decider 125 for evaluation against a threshold 190 for deploying the tuned LLM 180 to a production environment.

In one embodiment, deployment decider 125 is configured to automatically determine to deploy 193 the tuned large language model 180 to a text summarization task 196 in response to the evaluation score 185 satisfying a threshold 190. In one embodiment, deployment decider 125 is configured to automatically signal that the fine tuning of the tuned large language model 180 is complete in response to the evaluation score 185 satisfying a threshold 190. Employment decider 125 may automatically signal that the fine tuning is complete (or is not complete) by generation and/or transmission of an electronic message, such as an API call(s) to perform the deployment process (for example as discussed below, for example at paragraph [0092]). The signal may be detected, and used to launch, trigger, or otherwise cause the initiation of various subsequent actions regarding the tuned LLM 180. The signal that the fine tuning is complete may therefore be referred to occasionally herein as a “trigger” signal. For example, deployment decider 125 is configured to automatically generate a trigger signal that indicates that fine tuning of the tuned LLM 180 is complete. And, deployment decider 125 may be further configured to initiate an automated deployment of the tuned LLM 180 to a production environment in response to receipt of the trigger signal. Where the value of evaluation score 185 satisfies the threshold—that is, the condition(s) of threshold 190 evaluate to “TRUE” given the value of evaluation score 185—deployment decider 125 is configured to deploy 193 tuned large language model 180 to perform text summarization tasks 196 in a production environment.

In one embodiment, deployment decider 125 is configured to automatically determine not to deploy 193 the tuned large language model 180 to a text summarization task 196 in response to the evaluation score 185 failing to satisfy threshold 190. In one embodiment, deployment decider 125 may automatically generate a signal that indicates that fine tuning of the tuned LLM 180 is not yet complete, which may be referred to occasionally herein as a “retune” signal. And, deployment decider 125 may be further configured to initiate further training of the tuned LLM in response to receipt of the retune signal. Where the value of evaluation score 185 does not satisfy the threshold—that is, the condition(s) of threshold 190 evaluate to “FALSE” given the value of evaluation score 185—deployment decider 125 is configured to not deploy tuned large language model 180 to perform text summarization tasks 196 in a production environment. Instead, deployment decider 125 is configured to initiate a further epoch of training to further improve the trained LLM 180.

In one embodiment, where higher values of summarization loss represent better performance of an LLM at text summarization, threshold 190 is a minimum value for text summarization loss between reference summary 144 and 2nd new summary 187. (In another embodiment, where lower values of summarization loss represent better performance of an LLM at text summarization, threshold 190 is a maximum value for text summarization loss between reference summary 144 and 2nd new summary 187.) Additional conditions may also be included in threshold 190.

In one embodiment, the threshold 190 is set, as a minimum, at a previous maximum evaluation score achieved by the LLM before fine-tuning. Where the evaluation metric(s) are improved over the previous maximum score for text summarization, deployment decider 125 is configured to deploy 193 tuned LLM 180 to perform text summarization tasks 196. In this manner, deployment decider 125 is configured to determine whether the tuned LLM 180 is sufficiently fine-tuned for deployment.

In one embodiment, deployment decider 125 is configured to automatically determine to deploy the model to a text summarization task in response to the evaluation score 185 exceeding (or otherwise satisfying) a threshold 174. In one embodiment, deployment decider 125 is configured to generate a trigger signal that is configured to initiate or cause automated rollout of deployment of the tuned LLM to a production environment. In response to receiving the deployment trigger signal, the summarization tuning system 100 is configured to deploy 193 the tuned LLM 180.

In one embodiment, employment decider 125 is further configured to automatically deploy 193 the tuned LLM to the production environment to perform task summarization tasks 196. For example, deployment decider 125 is configured to deploy 193 an LLM by accepting or selecting the LLM for promotion to operation in a live or production environment. In one embodiment, deployment decider 125 is configured to automatically carry out the promotion of the LLM to the production environment. For example, the deployment decider 125 is configured to integrate the tuned LLM 180 into the production environment by automatically updating the model serving infrastructure, application programming interfaces (APIs), and/or other components used for operating the LLM to summarize text.

In one embodiment, deployment decider 125 is configured to automatically execute steps to replace a prior version of the LLM in the production environment with the tuned LLM 180. The automated deployment of the tuned LLM minimizes disruption to the production environment while incorporating the improved text summarization ability of tuned LLM 180. In one embodiment, deployment decider 125 is configured to automate deployment of the tuned LLM 180 by a process of administrator confirmation (optional), model serialization, and API integration.

As an optional initial step, an administrator is presented with a choice to confirm or reject the automated deployment of tuned LLM 180 into the production environment. For example, the choice may be presented as a user-selectable option (such as a button) in a graphical user interface to summarization tuning system 100.

Deployment decider 125 then proceeds to serialize the tuned LLM 180. Prior to serialization, tuned LLM 180 is represented as an object, such as a Python object. Deployment decider 125 encapsulates the architecture, learned weights for improved summarization performance, and other parameters of the tuned LLM 180 into a serialized format for storage as a data structure. For example, deployment decider 125 accesses and executes a serialization function (such as ‘dump( )’ in the ‘joblib’ library for the scikit-learn ecosystem) on the tuned LLM 180. Similar serialization functions are available in other machine learning ecosystems. The serialized, tuned LLM 180 may be loaded into memory or otherwise accessed from the serialized data structure. Deployment decider 125 writes the serialized, tuned LLM at a specified storage location in the production environment.

Deployment decider 125 then integrates the serialized, tuned LLM 180 into an existing API infrastructure for the production environment. Deployment decider updates the existing API endpoints and functionality to accommodate the tuned LLM 180. In one embodiment, discrete endpoints are defined to support various natural language processing tasks or functionalities. In one embodiment, there is an endpoint dedicated to text summarization tasks, which accepts parameters such as text to be summarized, maximum summary length, desired level of detail. For example, the endpoint path may be ‘/summarize_text’. Deployment decider 125 updates code for the text summarization endpoint in the production environment. The updates change the code for the text summarization endpoint to load the serialized, tuned LLM 180, rather than the serialized prior version of the LLM. For example, the code for the text summarization endpoint is modified to (i) initialize the serialized, tuned LLM 180 (rather than initializing the prior LLM) from the specified storage location, and (2) direct incoming text summarization requests to be handled by the initialized, tuned LLM 180 (rather than directing tasks to the prior LLM). Access to the prior LLM through the text summarization endpoint is discontinued by removal of code to initialize or direct requests to the prior LLM, and the serialized prior LLM may be removed from the production environment. In this way, the tuned LLM 180 that has been fined tuned to improve text summarization LLM may be automatically rolled out to the production environment.

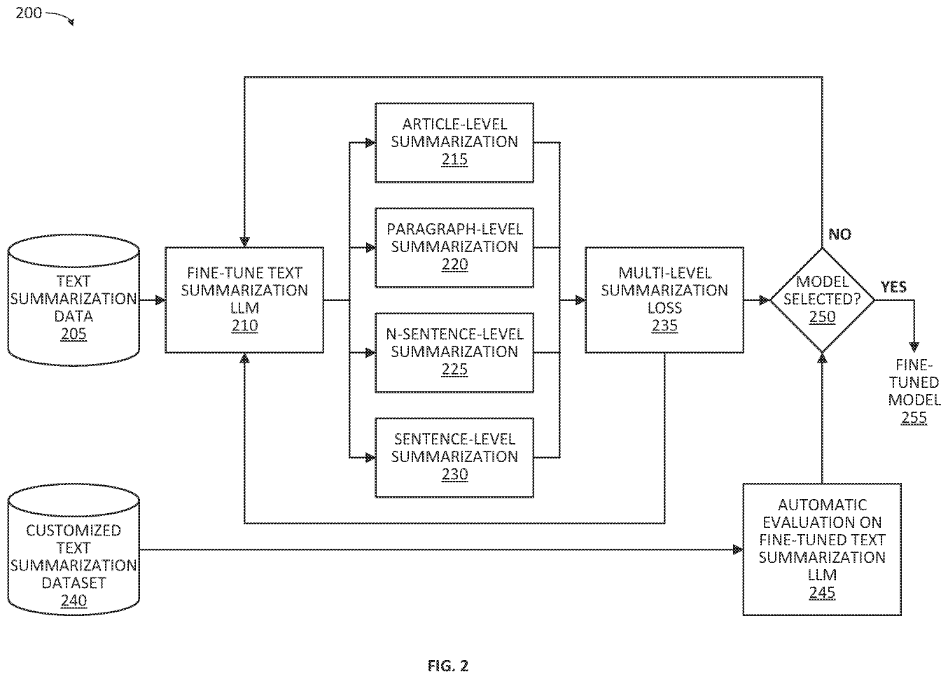

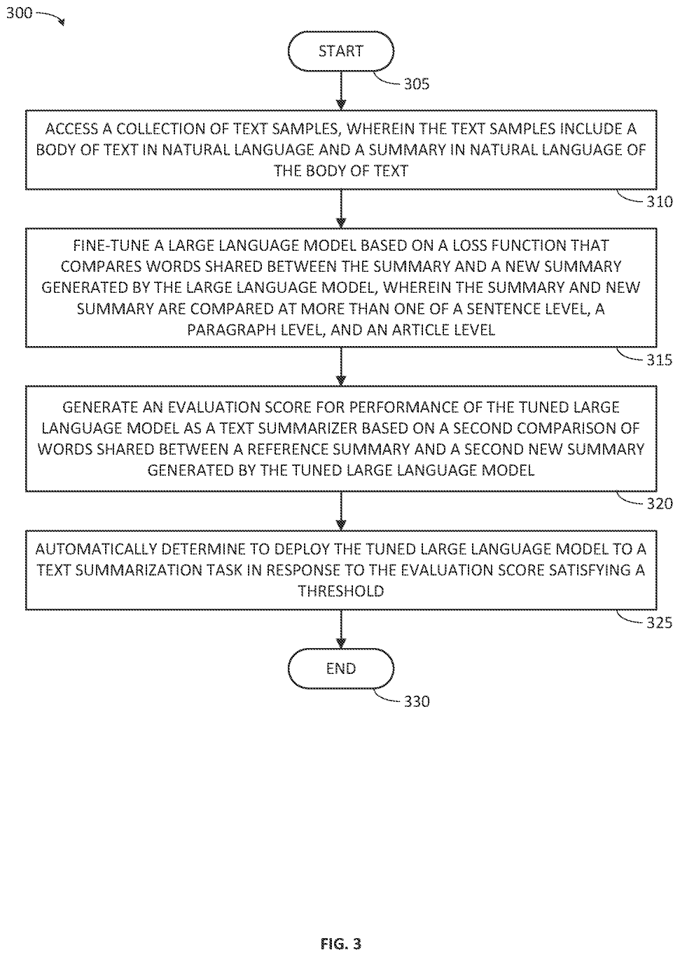

Further details regarding summarization tuning system 100 are presented herein. In one embodiment, the operation of summarization tuning system 100 to fine tune the LLM for a text summarization task will be described with reference to text summarization tuning pipeline 200 shown in FIG. 2 and example summarization tuning method 300 shown in FIG. 3.

### —LLM Fine-Tuning for Text Summarization—

As discussed above, a LLM may be configured to summarize natural language text. Given a longer piece of text, such as an article, document, or a web page, an LLM-based text summarizer is configured to generate a concise and coherent summary for its main ideas, key points, and important details.

In one embodiment, a summarization tuning system (such as summarization tuning system 100) implements a process or pipeline to fine-tune an LLM for the text summarization task. The summarization tuning system is configured to automatically improve the summaries generated by the LLM-based text summarizer. In order to improve the LLM's summarization ability, text summarization data (such as training data 150 and testing data 155) and a training loss function (such as summarization loss function 165) that are specific to text summarization are used to further fine-tune the LLM.

As an example of LLM-based text summarization, given a sentence/paragraph or other body of text that is input to the LLM, the LLM operates to summarize main ideas, key points, and details of the body of text as its output. An example of text summarization data is shown in Table 1 below:

TABLE 1

| Example | |
|---|---|
| Description | Example Input/Output |
| A summarization | Input: |
| scenario which | “(CNN) - An American woman died aboard a |
| summarizes | cruise ship that docked at Rio de Janeiro on |
| sentences/ | Tuesday, the same ship on which 86 passengers |
| paragraphs | previously fell ill, according to the state-run |
| | Brazilian news agency, Agencia Brasil. The |
| | American tourist died aboard the MS Veendam, |
| | owned by cruise operator Holland America. |
| | Federal Police told Agencia Brasil that forensic |
| | doctors were investigating her death. The ship's |
| | doctors told police that the woman was elderly |
| | and suffered from diabetes and hypertension, |
| | according the agency. The other passengers |
| | came down with diarrhea prior to her death during |
| | an earlier part of the trip, the ship's doctors said. |
| | The Veendam left New York 36 days ago for a |
| | South America tour.” |
| | Example (expected) output: |
| | “The elderly woman suffered from diabetes and |
| | hypertension, ship's doctors say. Previously, 86 |
| | passengers had fallen ill on the ship, Agencia |
| | Brasil says.” |

In one embodiment, at a high level, the summarization tuning system implements a pipeline to fine-tune an LLM for the text summarization task. Unlike traditional techniques which use prompt engineering or in-context learning to improve text summarization ability of the LLM, the summarization tuning system uses customized text summarization training data to fine-tune LLM weights (and/or other parameters) for optimized text summarization ability. Meanwhile, the summarization tuning system uses automatic text summarization evaluation to iteratively analyze the improvement/degradation of the fine-tuned LLM in order to obtain the optimized LLM weights for text summarization.

FIG. 2 illustrates an example summarization tuning pipeline 200 for automated fine-tuning of an LLM-based text summarizer. FIG. 2 provides a general overview of fine-tuning of LLM text summarization. In one embodiment, there are two main parts in summarization tuning pipeline 200: fine-tuning and auto-evaluation. In one embodiment, text summarization data specifically targets paragraphs with different subjects such as society, sports, politics, technology, and so on to fine-tune LLM's text summarization ability with a training process. The fine tuning uses a novel loss function design (as described in further detail elsewhere herein) that is specific to text summarization. The fine-tuned model is then processed by an automatic evaluation pipeline that is specifically configured for evaluating LLM text summarization. If the model satisfies selection metrics, the fine-tuned model will be selected to output. If not, the pipeline will trace back to the fine-tuning stage and keep fine-tuning the LLM on text summarization task to get better fine-tuned model.

In one embodiment, the fine-tuning part of summarization tuning pipeline 200 includes text summarization data 205, fine-tuning for text summarization 210, article-level summarization 215, paragraph-level summarization 220, N-sentence-level summarization 225, sentence-level summarization 230, and multi-level summarization loss function 235. And, the auto-evaluation part of summarization tuning pipeline 200 includes testing dataset for text summarization 240, automatic evaluation for text summarization 245, and model selection for text summarization 250. In one embodiment, summarization tuning pipeline 200 produces a fine-tuned model for text summarization 255 as output.

In one embodiment, text summarization data 205 (such as training data 150 from training database 105) includes a plurality of text samples (such as text sample 135) that demonstrate summarization of a text. In one embodiment, a text sample includes a body of natural language text (such as body of text 137), as well as a natural language example summary (such as example summary 138) of the body of text. In one embodiment, the example summary is written by a human. The text sample is configured to indicate that the body of text is an input for a LLM (such as LLM 160), and that the summary is an expected output (or “ground truth”) of the task of summarizing the body of text. For example, the body of text indicated to be “input” and the summary described as “example output” as shown in Table 1 above. The text samples may be used to train the LLM to mimic the human summarization.

In one embodiment, fine-tuning for text summarization 210 is configured to fine tune a LLM so as to adjust performance of the LLM at a task of summarizing content of written material, for example as described above with reference to LLM fine-tuner 115. Fine tuning for text summarization 210 is configured to execute a training process based on a novel combined loss function (such as summarization loss function 165). For example, the loss function may combine component functions for article level summarization 215, paragraph-level summarization 220, N-sentence level summarization 225, and sentence level summarization 230 into multi-level summarization loss function 235. In one embodiment, fine tuning for text summarization 210 trains the LLM to mimic human summarization through one or more epochs of the text samples. During the training, the weights of the LLM are adjusted by backpropagation to minimize the combined loss function. At the conclusion of a training epoch, the trained LLM will be evaluated as discussed at process blocks 240 and 245 below.

In one embodiment, article-level summarization 215 is a component (such as article loss 174) of the loss function that evaluates how well the overall article is represented by a generated summary. Article-level summarization 215 compares an LLM-generated summary of a body of text to an example summary of the body of text at an article level, evaluating the entire generated summary against the entire example summary. Article level summarization 215 is configured to calculate the recall and/or precision at word level between generated output and ground truth for article-level summarization. In other words, recall and/or precision of the generated summary is determined for the words that are included in the example summary. The recall and/or precision, normalized to the interval of 0 to 1, is an article-level summarization loss metric. In one embodiment, one article-level summarization loss metric is generated per generated summary. Thus, in one embodiment, article-level summarization 215 evaluates recall and precision for words of the example summary and the generated summary to produce an article-level loss.

In one embodiment, paragraph-level summarization 220 is a component (such as paragraph loss 172) of the loss function that evaluates how well individual paragraphs are represented in a generated summary. Paragraph-level summarization 220 compares an LLM-generated summary of a body of text to an example summary of the body of text at a paragraph level. Paragraph-level comparison evaluates paragraphs of the generated summary against paragraphs of the example summary that correspond in order of appearance to the paragraphs of the generated summary. Paragraph-level summarization 220 is configured to calculate the recall and/or precision at word level between generated output and ground truth for paragraph-level summarization. In other words, recall and/or precision of paragraphs of the generated summary is determined for the words of that are in corresponding paragraphs of the example summary. This recall and/or precision, normalized to the interval of 0 to 1, is a paragraph-level summarization loss metric. In one embodiment, multiple paragraph-level summarization loss metrics are generated per generated summary, with one paragraph-level summarization loss metric corresponding to each paragraph of the generated summary. These multiple paragraph-level summarization loss metrics may be averaged to provide a single output of sentence loss for paragraph-level summarization 230. Thus, in one embodiment, paragraph-level summarization 220 evaluates recall and precision for words of corresponding paragraphs of the example summary and the generated summary to produce a paragraph-level loss.

In one embodiment, N-sentence-level summarization 225 is a component of the loss function that evaluates how well particular groups of N sentences (i.e., series of a given number N of sentences which do not necessarily correspond to paragraphs) are represented in a generated summary. N-sentence-level summarization 225 compares an LLM-generated summary of a body of text to an example summary of the body of text at an N-sentence level. N-sentence-level summarization 225 is configured to calculate the recall and/or precision at word level between generated output and ground truth for several-sentence summarization. In other words, recall and/or precision of groups of N sentences of the generated summary is determined for the words of that are in corresponding groups of N-sentences of the example summary. This recall and/or precision, normalized to the interval of 0 to 1, is an N-sentence-level summarization loss metric. In one embodiment, multiple N-sentence-level summarization loss metrics are generated per generated summary, with one N-sentence-level summarization loss metric corresponding to each N-sentences of the generated summary. These multiple N-sentence-level summarization loss metrics may be averaged to provide a single output of N-sentence-level loss for N-sentence-level summarization 230. Thus, in one embodiment, N-sentence-level summarization 225 evaluates recall and precision for words of corresponding groups of N-sentences of the example summary and the generated summary to produce an N-sentence-level loss.

In one embodiment, sentence-level summarization 230 is a component (such as sentence loss 170) of the loss function that evaluates how well individual sentences are represented in a generated summary. Sentence-level summarization 230 compares an LLM-generated summary of a body of text to an example summary of the body of text at a sentence level. Sentence-level summarization 230 is configured to calculate the recall and/or precision at word level between generated output and ground truth for a sentence-level summarization. In other words, recall and/or precision of sentences of the generated summary is determined for the words of that are in corresponding sentences of the example summary. This recall and/or precision, normalized to the interval of 0 to 1, is a sentence-level summarization loss metric. In one embodiment, multiple sentence-level summarization loss metrics are generated per generated summary, with one sentence-level summarization loss metric corresponding to each sentence of the generated summary. These multiple sentence level summarization loss metrics may be averaged to provide a single output of sentence-level loss for sentence-level summarization 230. Thus, in one embodiment, sentence-level summarization 230 evaluates recall and precision for words of corresponding sentences of the example summary and the generated summary to produce a sentence-level loss.

In one embodiment, multi-level summarization loss function 235 (such as summarization loss function 165) is configured to merge the summarization losses from the article-level, paragraph-level, N-sentence-level, and sentence level loss functions into a single multi-level summarization loss value. For example, multi-level summarization loss function 235 may average the outputs of article level summarization 215, paragraph-level summarization 220, N-sentence level summarization 225, sentence level summarization 230, and multi-level summarization loss function 235. For example, multi-level summarization loss function 235 may average the precision scores from a plurality of of the loss functions 215, 220, 225, 230, and may average the recall scores from the plurality of the loss functions 215, 220, 225, 230.

In this way, the comparison of words shared between the LLM-generated summary and the example summary includes generating an overall value of precision between the LLM-generated summary and the example summary. The overall value of precision combines or incorporates a plurality of article-level precision, paragraph-level precision, N-sentence-level precision, and sentence-level precision values. And, the comparison of words shared between the LLM-generated summary and the example summary includes generating an overall value of recall between the LLM-generated summary and the example summary. The overall value of recall combines or incorporates a plurality of article-level recall, paragraph-level recall, N-sentence-level recall, and sentence-level recall values. In one embodiment, the overall values for precision and recall may further be combined, for example by averaging the scores in an average or weighted average to produce a single value for loss that incorporates the various features of summarization loss across all levels into one value for multi-level summarization loss. Thus, multi-level summarization loss function 235 combines the sentence-level loss, the paragraph-level loss, and the article-level loss in one loss function.

In one embodiment, testing dataset for text summarization 240 (such as testing data 155 from golden testing database 130) is a separate dataset for testing and/or validation of LLM performance with respect to text summarization. Like text summarization data 205, testing dataset for text summarization 240 includes a plurality of text samples (such as reference text sample 140) that demonstrate summarization of a text with a body of text (e.g., reference body of text 143) and a summary of the text (e.g., reference summary 144). In one embodiment, testing dataset for text summarization 240 includes a few hundred to a few thousand text samples, for example, 1000 text samples.

In one embodiment, testing dataset for text summarization 240 is a golden or benchmarking dataset. The golden data is used as a reference for testing text summarization performance. In one embodiment, the golden data is formatted as pairs of input bodies of text and output example summaries of the text, such as shown above with reference to TABLE 1. The output example summaries of the text may be human-generated summaries, or computer-generated summaries that have been deemed (upon review) to be representative of acceptable summarization. For example, the output example summaries may exhibit acceptable averaged recall/precision scores under the multi-level summarization loss function 235. In short, the golden data provides a reference, benchmark, or other standard demonstrating an expected quality level for summaries.

In one embodiment, automatic evaluation for text summarization 245 (such as may be performed by automatic LLM evaluator 120) is configured to quantify how well the LLM performs as a text summarization tool following training. In one embodiment, automatic evaluation for text summarization 245 evaluates LLM summarization performance based, at least in part, on recall and/or precision scores between the example summary (ground truth) and the generated summary. In one embodiment, automatic evaluation for text summarization 245 evaluates LLM summarization performance based, at least in part, on scores for criteria for summarization performance in addition to recall and precision. Automatic evaluation for text summarization 245 incorporates the scores for the various criteria into an overall evaluation score. In one embodiment, automatic evaluation for text summarization 245 produces a tuple of the recall score, and the precision score as output. In one embodiment, the tuple may further include one or more scores for additional criteria, such as a word count score, a repetition score, a human-readability score, a relevance score, and/or a conciseness score. In one embodiment, the recall score and the precision score (and any scores for additional criteria) may be respectively weighted to emphasize or de-emphasize a score as a component of the evaluation score. In one embodiment, the recall score and the precision score (and any scores for additional criteria) may be averaged into one value for the evaluation score. Thus, in one embodiment, automatic evaluation for text summarization 245 combines one or more component scores to produce an evaluation score or scores for how well an LLM summarizes text.

In one embodiment, automatic evaluation for text summarization 245 is configured to evaluate additional criteria for summarization performance. For example, automatic evaluation for text summarization 245 may generate scores for the additional criteria, and incorporate the scores for the additional criteria into the evaluation score. Automatic evaluation for text summarization 245 may incorporate a word count score into the evaluation score. The word count score indicates how well a generated summary complies with a specified (or expected) output length. And, for example, multi-level summarization loss function 235 may incorporate scores for repetition, human-readability, relevance, conciseness into the evaluation score. The repetition core indicates an extent to which a generated summary is repetitive. The human-readability score indicates an extent to which a generated summary is coherent to a human reader (such as by exhibiting proper grammar and syntax). The relevance score indicates an extent to which a generated summary is relevant to the input body of text. The conciseness score indicates the extent to which a generated summary is succinct while effectively capturing the key points or main ideas of the input body of text.

In one embodiment, automatic evaluation for text summarization 245 evaluates text summarization performance by the LLM based, at least in part, on a word count of the generated summary. Therefore, in one embodiment, automatic evaluation for text summarization 245 generates a word count of the generated summary. In one embodiment, an absolute cap is enforced on word count of the summary, for example, 100 words. In one embodiment, the cap on word count is based on a proportion of an overall size (length) of the body of text being summarized, for example, between 1% and 10%, such as 5% of the length of the body of text. In one embodiment, the cap on word count is based on a proportion of an overall size (length) of an example summary of the body of text, for example, between 100% and 110%, such as 105% of the length of the example summary associated with the body of text.

Automatic evaluation for text summarization 245 imposes a penalty for exceeding the word count. In one embodiment, the penalty may be fixed, and in another embodiment, the penalty may be proportional to the amount by which the summary exceeds the word count. In one embodiment, automatic evaluation for text summarization generates the word count score based on the word count, and which applies the penalty for exceeding the word count. The word count score indicates an extent to which the generated summary complies with the cap on length for summaries, that is, the extent to which the word count remains below the cap.

In one embodiment, automatic evaluation for text summarization 245 evaluates text summarization performance by the LLM based, at least in part, on the scores for repetition, human-readability, relevance, conciseness, or other additional criteria. In one embodiment, automatic evaluation for text summarization 245 may generate the scores for these additional criteria using an additional LLM other than the LLM being fine-tuned. For example, automatic evaluation for text summarization 245 may prompt or ask the additional LLM to score the LLM-generated summary (such as a summary generated by the tuned LLM) for satisfaction of one or more specified criteria. Automatic evaluation for text summarization 245 may retrieve a pre-composed prompt regarding a criterion, and submit the prompt, populated with the LLM-generated summary, to cause the additional LLM to produce a score for the criterion. In the cases of scoring for relevance and conciseness, automatic evaluation for text summarization 245 will further include the body of text in the submission to the additional LLM.

Automatic evaluation for text summarization 245 stores the score for the additional criteria produced by the additional LLM in response to submission of the prompt. For example, automatic evaluation for text summarization 245 may parse the response(s) of the additional LLM to extract the score(s) for the additional criteria. In one embodiment, scores produced by the additional LLM may be normalized to the range from 0 to 1 (where the scores produced by the additional LLM are not already normalized to the range from 0 to 1). In one embodiment, various weights may be applied to the scores for the additional criteria scores to emphasize or de-emphasize a given criteria. In this way, the evaluation score may be further based on the response(s) generated by the additional LLM regarding the specified criteria.

For example, automatic evaluation for text summarization 245 may prompt the additional LLM to score the generated output on the criterion of repetitiveness with a prompt such as: “Grade, on a scale from 0 to 1, is [LLM-generated summary] non-repetitive?” Or, for example, automatic evaluation for text summarization 245 may prompt the additional LLM to score the generated output for human-readability with a prompt such as, “Measure how human-readable [LLM-generated summary] is on a scale from 0 to 1.” In another example, automatic evaluation for text summarization 245 may prompt the additional LLM to score for relevance with a prompt such as, “On a scale from 0 to 1, how relevant is [LLM-generated summary] to [body of text]?”

In one embodiment, model selection for text summarization 250 is configured to determine whether the LLM has improved over its prior peak ability to summarize text, for example as described above with reference to deployment decider 125. In one embodiment, if the text summarization performance of the LLM has improved, the LLM is to be considered to have satisfied the conditions (e.g., threshold 190) for being “fine-tuned” with respect to the text summarization task. In another embodiment, the text summarization performance is considered to satisfy the conditions for being “fine-tuned” where the improvement exceeds the prior peak by at least a pre-set ratio. Where the LLM is considered to be fine-tuned, the LLM is selected for deployment into a production environment to summarize further texts (e.g., text summarization tasks 196). If the LLM does not satisfy the conditions for being considered “fine-tuned”, the summarization tuning pipeline 200 returns to block 210 for an additional epoch of training with further text samples.

### —Example Summarization Tuning Method—

FIG. 3 illustrates one embodiment of a summarization tuning method 300 associated with automated LLM fine-tuning for text summarization. In one embodiment, as a general overview, summarization tuning method 300 is a technique to fine-tune an LLM in order to improve summarization ability of the LLM based on a collection of customized text summarization data. In one embodiment, summarization tuning method 300 may implement an automatic evaluation pipeline that analyzes the text summarization ability of an LLM that has been fine-tuned, such as summarization tuning pipeline 200 shown and described with reference to FIG. 2. The analysis is automatic, and based on an automatic metric calculation (such as in summarization loss function 160 or summarization loss function 235), thereby fully automating evaluation of summarization output.

In one embodiment, summarization tuning method 300 uses training data customized for text summarization to fine-tune LLM weights for optimized text summarization ability. Summarization tuning method 300 implements an automated evaluation of text summarization that iteratively analyzes the improvement (or degradation) the fine-tuned LLM to obtain optimized (or more accurate) LLM weights for text summarization.

In one embodiment, the summarization tuning method 300 accesses a collection of text samples, wherein the text samples include a body of text in natural language and a summary in natural language of the body of text. The summarization tuning method 300 fine-tunes a large language model based on a loss function that compares words shared between the summary and a new summary generated by the large language model. The summary and new summary are compared at more than one of a sentence level, a paragraph level, and an article level. The summarization tuning method 300 generates an evaluation score for performance of the trained LLM as a text summarizer based on a second comparison of words shared between a test summary and a second new summary generated by the large language model. The summarization tuning method 300 automatically determines to apply the model to a text summarization task in response to the evaluation score exceeding a threshold.

In one embodiment, summarization tuning method 300 initiates at START block 305 in response to an LLM tuning system determining that (i) an instruction to perform the summarization tuning method 300 has been received by LLM tuning system; (ii) it is currently a time at which the summarization tuning method 300 is scheduled to be run; (iii) a retune signal has been received indicating that an LLM being fine-tuned has not yet satisfied a threshold for summarization performance; or (iv) that summarization tuning method 300 should commence in response to some other condition. In one embodiment, a computer system configured by computer-executable instructions to execute functions of summarization tuning system 100 and/or summarization tuning pipeline 200 executes the text summarization tuning method 300. Following initiation at START block 305, summarization tuning method 300 continues to block 310.

At block 310, summarization tuning method 300 accesses a collection of text samples. The text samples include a body of text in natural language and a summary in natural language of the body of text. In one embodiment, summarization tuning method 300 (i) initializes a data handler component (such as data handler 110); (ii) establishes a connection to a training database (such as training database 105); (iii) retrieves a sufficient quantity of text samples (such as text samples 135) from the training database to be used for a training epoch; (iv) parses the text samples to extract the body of text and its corresponding summary; and (v) provides the bodies of text and corresponding summaries as training data 150 for an epoch of training of the LLM. In one embodiment, the parsed samples are organized in the training data 150 as a data structure (such as a table or an array) that maintains an association between each body of text and its respective summary. In this manner, the text samples are accessed and configured for subsequent operations to fine-tune the LLM.

In one embodiment, summarization tuning method 300 also (i) establishes a connection to a reference database (such as golden testing database 130); (ii) retrieves at least one reference text sample (such as reference text samples 140) from the reference database to be used for evaluation of summarization performance of the LLM after fine tuning; (iii) parses the reference text sample to extract the reference body of text and its corresponding reference summary; and (iv) provides the reference body of text and corresponding summary as testing data 155 for evaluating an epoch of training of the LLM. In this manner, the reference text samples are accessed and configured for subsequent operations to evaluate the fine-tuning of the LLM.

At block 315, summarization tuning method 300 fine-tunes a large language model based on a loss function. The loss function compares words shared between the example summary and a new summary generated by the large language model. The example summary and new, LLM-generated summary are compared at more than one of a sentence level, a paragraph level, and an article level. In one embodiment, the summarization tuning method 300 iteratively compares the example and LLM-generated summaries using the loss function; and (ii) adjusts the weights for the LLM to increase similarity between the example and LLM-generated summaries.

In one embodiment, the loss function (such as summarization loss function 165) generates numerical outputs such as recall and/or precision values. The numerical outputs describe similarity or difference between an LLM-generated new summary and an example summary provided in association with a particular body of text in training data 150. (The example summary shows what a summary of the body of text in the training is “expected” to be or resemble.) And, in one embodiment, the loss function 165 is a composite loss function that evaluates the similarity between the reference summary and the generated summary at multiple different levels. For example, the loss function compares the example and LLM-generated summaries at a sentence level (e.g., using a sentence loss function 170); assesses the representation of individual paragraphs in the generated summary (e.g., using a paragraph loss function 172); and evaluates how well the overall article is represented by the generated summary (e.g., using an article loss function 174). Additionally, the loss function may evaluate how well particular groups of N sentences are represented in the generated summary. In one embodiment, summarization tuning method 300 normalizes the outputs (e.g., the values of recall and precision) of these individual component loss functions to a shared range, such as 0 to 1. In one embodiment, summarization tuning method 300 generates the outputs of the combined, multi-level loss function by averaging the outputs from the component loss functions.

In one embodiment, summarization tuning method 300 initializes an LLM fine-tuner component (such as LLM fine-tuner 115). In one embodiment, the LLM fine-tuner (i) selects a batch of text samples (bodies of text and their associated example summaries) from training data 150; (ii) executes the LLM to produce new or additional LLM-generated summaries for bodies of text in the batch; (iii) executes the loss function to compare the example and LLM-generated summaries associated with the bodies of text in the batch; and (iv) updates the weights of the model—for example by backpropagation in a direction on a gradient of the loss function—to reduce or minimize the loss for the batch. The LLM fine-tuner may repeat these steps for multiple batches of text samples, for example until all samples of the epoch are processed. At the conclusion of block 315, summarization tuning method 300 has produced a re-trained, updated, or tuned LLM (such as tuned LLM 180). The tuned LLM is then submitted for evaluation of its summarization capabilities, for example by automatic LLM evaluator 120.

At block 320, summarization tuning method 300 generates an evaluation score (such as evaluation score 185) for performance of the tuned large language model as a text summarizer. The evaluation score is generated based on a second comparison of words shared between a reference summary and a second new summary generated by the tuned large language model. In one embodiment, the summarization tuning method 300 initializes an automatic LLM evaluator (such as automatic LLM evaluator 120). The automatic LLM evaluator executes the summarization loss function to compare the reference summary (e.g., reference summary 144) given in the reference text sample (e.g., reference text sample 140) for the reference body of text (e.g., reference body of text 143) with yet another new summary (such as second new summary 187) that was generated by the tuned LLM from the reference body of text.

The automatic LLM evaluator generates an evaluation score based on the outputs of the summarization loss function—for example, values of recall, precision, and/or word count—for the comparison between the reference and the LLM-generated summaries of the reference body of text. In one embodiment, the evaluation score is a tuple incorporating values of recall, precision, and/or word count. In one embodiment, the evaluation score averages a plurality of values, such as the values of values of recall and precision generated by the loss function, into one value. This average may be weighted or unweighted. The evaluation score may thus be a composite score that is, incorporates, or is otherwise based on the summarization loss between the reference and the LLM-generated summaries. The summarization tuning method then provides the evaluation score to determine whether the tuned LLM is sufficiently fine-tuned for deployment.

At block 325, summarization tuning method 300 automatically determines whether fine tuning of the tuned large language model is complete in response to the evaluation score satisfying a threshold. In one embodiment, where the threshold is not satisfied, summarization tuning method 300 generates a retune signal to cause summarization tuning method 300 to repeat for the tuned large language model, for example from block 310 above. Where the threshold is satisfied, summarization tuning method generates a trigger signal to initiate or cause automated deployment of the tuned large language model to a production environment for performance of text summarization tasks. For example, summarization tuning method 300 automatically determines to deploy the tuned large language model to a text summarization task. The deployment is determined in response to the evaluation score satisfying a threshold.

In one embodiment, the summarization tuning method 300 initializes a deployment decider (such as deployment decider 125) to automatically determine whether to deploy the tuned LLM based on satisfying a threshold for LLM summarization performance, or to repeat the fine-tuning process for further training epochs based on failure to satisfy the threshold. The deployment decider defines a threshold (such as threshold 190) for the evaluation score based on pre-determined performance criteria for the LLM, such as improvement over a previous “best” evaluation score achieved by the LLM under a prior iteration of tuning. The deployment decider then populates the threshold conditions by inputting the value(s) of the evaluation score. For example, values for recall, precision, and/or word count may be entered where the threshold conditions evaluate these aspects separately. In one embodiment, where a single combined (e.g., averaged) value is used for the evaluation score, the single value is entered for comparison with the previous best evaluation score. The deployment decider evaluates the populated threshold to determine whether the threshold evaluates to a value (such as a Boolean “TRUE”) that indicates the threshold to be satisfied by the evaluation score.

If the evaluation shows improvement over the previous best score for text summarization performance by the threshold amount, the deployment decider automatically deploys the tuned LLM for text summarization tasks. If insufficient improvement in performance, or even decrease in performance, is detected by the evaluation, the tuned LLM is not deployed. Instead, the deployment decider initiates further epochs of training with additional text samples for the tuned LLM, restarting summarization tuning method 300 at block 310 for the tuned LLM. In one embodiment, once the deployment decider has determined to deploy the tuned LLM, deployment decider automatically carries out the promotion of the LLM to the production environment. In one embodiment, the determination to deploy the tuned LLM may be presented in a user interface, such as a graphical user interface, for user or administrator confirmation or rejection of the deployment.

In one embodiment, the threshold is defined by retrieving a pre-specified threshold is retrieved from storage. In one embodiment, the threshold is defined by dynamically adjusting threshold conditions based on the previous “best” evaluation score—a prior peak ability of the LLM to summarize text. The previous “best” score may be, for example, a maximum score where higher scores indicate better summarization performance. The automatic LLM evaluator may be configured to also store the previous best evaluation score that was previously achieved by the LLM. In one embodiment, the value(s) of the previous best score, for example the values of recall and precision may be set as minimum conditions to be exceeded in the threshold evaluation. In one embodiment, the values of the previous best score, plus a pre-determined margin of improvement, are set as minimum conditions to be exceeded in the threshold evaluation. And, a pre-specified value of word count-pre-specified, or previously achieved by the LLM—may be set as a maximum not to be exceeded in the threshold evaluation. In one embodiment, the average (such as a weighted average) of the previous best value of recall and the previous best value of precision is set as the as the minimum condition to be exceeded in the threshold evaluation. In one embodiment, the previous best average (such as a weighted average) of recall and precision is set as the as the minimum condition to be exceeded in the threshold evaluation.

At the conclusion of block 325, summarization tuning method 300 proceeds to END block 330, where summarization tuning method 300 terminates. At the conclusion of summarization tuning method 300, an LLM has been automatically fine-tuned for improved performance at summarizing text, and automatically deployed to implement the improved summarization capabilities for ongoing text summarization tasks.

### —Example Features of Summarization Tuning Method—

In one embodiment, comparison of the example and LLM-generated summaries associated with the bodies of text (as discussed for block 315) further includes generating a value of recall between the example summary and the generated summary. Such comparison is described in further detail above, for example with reference to the various summarization components 215, 220, 225, and 230 of multi-level summarization loss 235, and to summarization loss function 165.

In one embodiment, comparison of the example and LLM-generated summaries associated with the bodies of text (as discussed for block 315) further includes generating a value of precision between the example summary and the generated summary. Such comparison is described in further detail above, for example with reference to the various summarization components 215, 220, 225, and 230 of multi-level summarization loss 235, and to summarization loss function 165.

In one embodiment, summarization tuning method 300 compares the example summary and the generated summary (as discussed for block 315) at the sentence level. The example summary and generated summary are compared by determining recall and precision of sentences of the generated summary for words appearing in corresponding sentences of the example summary, for example as discussed above with reference to sentence-level summarization 230 and summarization loss function 165. Note, where a portion of text such as word(s), sequence(s) or subsequence(s) of words, sentence(s), paragraph(s), or N-sentence group(s) are referred to as being “of” a larger text (such as a sentence, paragraph, summary, or body of text), such use of the term “of” indicates that the portion of text is included or contained in or otherwise belongs to the larger text.

In one embodiment, summarization tuning method 300 compares the example summary and the generated summary (as discussed for block 315) at the paragraph level. The example summary and generated summary are compared by determining recall and precision of paragraphs of the generated summary for words appearing in corresponding paragraphs of the example summary, for example as discussed above with reference to paragraph-level summarization 220 and summarization loss function 165.

In one embodiment, summarization tuning method 300 compares the example summary and the generated summary (as discussed for block 315) at the article level. The example summary and generated summary are compared by determining recall and precision of the generated summary for words appearing in the example summary, for example as discussed above with reference to article-level summarization 215 and summarization loss function 165.

In one embodiment, summarization tuning method 300 compares the example summary and the generated summary (as discussed for block 315) at the N-sentence level. The example summary and generated summary are compared by determining recall and precision of groups of N-sentences of the generated summary for words appearing in corresponding groups of N-sentences of the example summary, for example as discussed above with reference to groups of N-sentence-level summarization 225 and summarization loss function 165.

In one embodiment, generation of the evaluation score for performance of the tuned large language model as a text summarizer (as discussed for block 320) further includes generating a word count of the generated summary (as discussed with reference to automatic evaluation for text summarization 245). And, the generation of the evaluation score further includes generating a word count score (based on the word count) that indicates an extent to which the word count complies with a cap on length for summaries. The word count score is incorporated in the evaluation score, for example by inclusion of the value of the word count score in a tuple or in a weighted average along with other values, such as scores for precision and/or recall.

In one embodiment, generation of the evaluation score for performance of the tuned large language model as a text summarizer (as discussed for block 320) further includes prompting an additional large language model to score the second generated summary for a specified criterion (as discussed with reference to automatic evaluation for text summarization 245). Note, the second generated summary was generated by the tuned large language model. And, the generation of the evaluation score further includes further basing the evaluation score on a response generated by the second large language model regarding the criterion.

In one embodiment, the example summary and generated summary are compared at more than one of a sentence level, a paragraph level, and an article level as discussed above with reference to block 315, summarization loss function 165, and multi-level summarization loss function 235.

In one embodiment, comparison of words shared between shared between the example summary and the LLM-generated summary (as discussed for block 315) further includes generating a value of precision between the example summary and the generated summary. And, the comparison of words shared also includes generating a value of precision between the example summary and the generated summary. Comparison of words in this manner is described in further detail above, for example with reference to the various summarization components 215, 220, 225, and 230 of multi-level summarization loss 235, and to summarization loss function 165).

In one embodiment, comparison of words shared between shared between the example summary and the LLM-generated summary (as discussed for block 315) further includes steps for evaluating multi-level summarization loss in the loss function. The comparison of words further includes evaluating recall and precision for words of corresponding sentences of the example summary and the generated summary to produce a sentence-level loss, for example as discussed above with reference to sentence-level summarization 230 and summarization loss function 165. The comparison of words further includes evaluating recall and precision for words of corresponding paragraphs of the example summary and the generated summary to produce a paragraph-level loss, for example as discussed above with reference to paragraph-level summarization 220 and summarization loss function 165. The comparison of words further includes evaluating recall and precision for words of the example summary and the generated summary to produce an article-level loss, for example as discussed above with reference to article-level summarization 215 and summarization loss function 165. And, the comparison of words further includes combining the sentence-level loss, the paragraph-level loss, and the article-level loss in the loss function.

### —Cloud or Enterprise Embodiments—

In one embodiment, the present system (such as summarization tuning system 100) is a computing/data processing system including a computing application or collection of distributed computing applications for access and use by other client computing devices that communicate with the present system over a network. In one embodiment, summarization tuning system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, summarization tuning system 100 is a centralized server-side application that provides at least the functions disclosed herein and that is accessed by many users by way of computing devices/terminals communicating with the computers of summarization tuning system 100 (functioning as one or more servers) over a computer network. In one embodiment summarization tuning system 100 may be implemented by a server or other computing device configured with hardware and software to implement the functions and features described herein.

In one embodiment, the components of summarization tuning system 100 may be implemented as sets of one or more software modules executed by one or more computing devices specially configured for such execution. In one embodiment, the components of summarization tuning system 100 are implemented on one or more hardware computing devices or hosts interconnected by a data network. For example, the components of summarization tuning system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes. In one embodiment, as a practical matter, summarization tuning system 100 may employ GPU hardware resources for fine-tuning an LLM for text summarization in order to complete retraining of the weights of the LLM within a reasonable period of time.

In one embodiment, the components of summarization tuning system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of summarization tuning system 100 may (i) generate or compose an electronic message or signal to issue a command or request to another component, (ii) transmit the message or signal to other components of summarization tuning system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by summarization tuning system 100, for example through a web interface server. In one embodiment, the remote computing system may send requests to and receive responses from summarization tuning system 100. In one example, access to the information or applications may be effected through use of a web browser on a personal computer or mobile device. In one example, communications exchanged with summarization tuning system 100 may take the form of remote representational state transfer (REST) requests using JavaScript object notation (JSON) as the data interchange format for example, or simple object access protocol (SOAP) requests to and from XML servers. The REST or SOAP requests may include API calls to components of LLM tuning system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

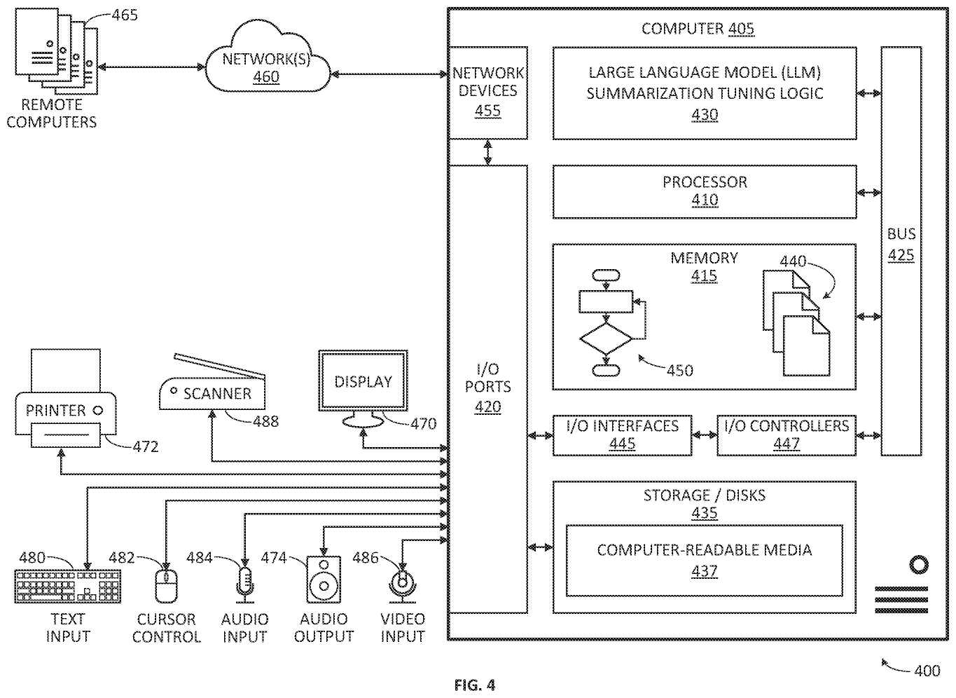

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include LLM summarization tuning logic 430 configured to facilitate automated fine-tuning of an LLM to improve text summarization functionality of the LLM, similar to logic, systems and methods shown in and described with reference to FIGS. 1-3.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate automated fine-tuning for large language models. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks with which the computer 405 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

1. One or more non-transitory computer-readable media that include stored thereon computer-executable instructions that when executed by at least a processor of a computer system cause the computer system to:
access a collection of text samples, wherein the text samples include a body of text in natural language and an example summary in natural language of the body of text;
fine-tune a large language model based on a loss function that compares the example summary and a generated summary generated by the large language model, wherein the example summary and the generated summary are compared at more than one of a sentence level, a paragraph level, and an article level;
generate an evaluation score for performance of the tuned large language model as a text summarizer based on a second comparison of a reference summary and a second generated summary generated by the tuned large language model; and
automatically signal that the fine tuning of the tuned large language model is complete in response to the evaluation score satisfying a threshold.

2. The non-transitory computer-readable media of claim 1, wherein the instructions further cause the computer system to generate a value of recall between the example summary and the generated summary.

3. The non-transitory computer-readable media of claim 1, wherein the instructions further cause the computer system to generate a value of precision between the example summary and the generated summary.

4. The non-transitory computer-readable media of claim 1, wherein the instructions further cause the computer system to compare the example summary and the generated summary at the sentence level by determining recall and precision of sentences of the generated summary for words appearing in corresponding sentences of the example summary.

5. The non-transitory computer-readable media of claim 1, wherein the instructions further cause the computer system to compare the example summary and the generated summary at the paragraph level by determining recall and precision of paragraphs of the generated summary for words appearing in corresponding paragraphs of the example summary.

6. The non-transitory computer-readable media of claim 1, wherein the instructions further cause the computer system to compare the example summary and the generated summary at the article level by determining recall and precision of the generated summary for words appearing in the example summary.

7. The non-transitory computer-readable media of claim 1, wherein the instructions further cause the computer system to compare the example summary and the generated summary at an N-sentence-level level by determining recall and precision of groups of N sentences of the generated summary for words appearing in corresponding groups of N sentences in the example summary.

8. The non-transitory computer-readable media of claim 1, wherein the instructions to generate an evaluation score for performance of the tuned large language model as a text summarizer further cause the computer system to:
generate a word count of the generated summary; and
generate a word count score that indicates an extent to which the word count complies with a cap on length for summaries, wherein the word count score is incorporated in the evaluation score.

9. The non-transitory computer-readable media of claim 1, wherein the instructions to generate an evaluation score for performance of the tuned large language model as a text summarizer further cause the computer system to:
prompt an additional large language model to score the second generated summary for a specified criterion; and
further base the evaluation score on a response generated by the second large language model regarding the criterion.

10. A computer-implemented method, comprising:
accessing a collection of text samples, wherein the text samples include a body of text in natural language and an example summary in natural language of the body of text;
fine-tuning a large language model based on a loss function that compares words shared between the example summary and a generated summary generated by the large language model;
generating an evaluation score for performance of the tuned large language model as a text summarizer based on a second comparison of words shared between a reference summary and a second generated summary generated by the tuned large language model; and
automatically determining to deploy the tuned large language model to a text summarization task in response to the evaluation score satisfying a threshold.

11. The computer-implemented method of claim 10, wherein the example summary and generated summary are compared at more than one of a sentence level, a paragraph level, and an article level.

12. The computer-implemented method of claim 10, wherein the comparison of words shared between the example summary and the generated summary further comprises:
generating a value of precision between the generated summary and the example summary; and
generating a value of recall between the generated summary and the example summary.

13. The computer-implemented method of claim 10, wherein the comparison of words shared between the example summary and the generated summary further comprises:
evaluating recall and precision for words of corresponding sentences of the example summary and the generated summary to produce a sentence-level loss;
evaluating recall and precision for words of corresponding paragraphs of the example summary and the generated summary to produce a paragraph-level loss;
evaluating recall and precision for words of the example summary and the generated summary to produce an article-level loss; and
combining the sentence-level loss, the paragraph-level loss, and the article-level loss in the loss function.

14. The computer-implemented method of claim 10, wherein generating the evaluation score further comprises:
generating a word count of the generated summary; and
generating a word count score based on the word count that indicates an extent to which the generated summary complies with a cap on length for summaries.

15. The computer-implemented method of claim 10, wherein generating an evaluation score for performance of the tuned large language model as a text summarizer further comprises:
prompting an additional large language model to score the second generated summary for a specified criterion, wherein the criterion is one of repetition, human-readability, relevance, or conciseness; and
further basing the evaluation score on a response generated by the second large language model regarding the criterion.

16. A computing system, comprising:
at least one processor connected to at least one memory;
one or more non-transitory computer-readable media that include stored thereon computer-executable instructions that when executed by at least the processor accessing the memory cause the computing system to:
access a collection of text samples, wherein the text samples include a body of text in natural language and an example summary in natural language of the body of text;
retrain a large language model based on a loss function that compares words shared between the example summary and a generated summary generated by the large language model;
generate an evaluation score for performance of the tuned large language model as a text summarizer based on a second comparison of words shared between a reference summary and a second generated summary generated by the tuned large language model; and
automatically determine to deploy the tuned large language model to a text summarization task in response to the evaluation score satisfying a threshold.

17. The computing system of claim 16, wherein when executed, the instructions for the comparison of words shared between the example summary and the generated summary further cause the computing system to:
generate a plurality of values of precision between the generated summary and the example summary; and
generate a plurality of values of recall between the generated summary and the example summary.

18. The computing system of claim 16, wherein when executed, the instructions for the comparison of words shared between the example summary and the generated summary further cause the computing system to:
evaluate recall and precision for words of corresponding sentences of the example summary and the generated summary to produce a sentence-level loss;
evaluate recall and precision for words of corresponding paragraphs of the example summary and the generated summary to produce a paragraph-level loss;
evaluate recall and precision for words of the example summary and the generated summary to produce an article-level loss; and
combine the sentence-level loss, the paragraph-level loss, and the article-level loss in the loss function.

19. The computing system of claim 16, wherein when executed, the instructions for generation of the evaluation score further cause the computing system to:
generating a word count of the generated summary; and
generating a word count score based on the word count that indicates an extent to which the generated summary complies with a cap on length for summaries.

20. The computing system of claim 16, wherein when executed, the instructions for generation of the evaluation score further cause the computing system to:
prompting an additional large language model to score the second generated summary for a specified criterion, wherein the criterion is one of repetition, human-readability, relevance, or conciseness; and
further basing the evaluation score on a response generated by the second large language model regarding the criterion.
